(19) United States
(12) Patent Application Publication
(10) Pub. No.: US 2017/0345317 A1
(43) Pub. Date: Nov. 30, 2017

(54) DYNAMIC ROUTING BASED ON CAPTURED DATA QUALITY

(71) Applicant: Sharper Shape Oy, Espoo (FI)

(72) Inventors: Tero Heinonen, Jarvenpaa (FI); Atte Korhonen, Espoo (FI)

(21) Appl. No.: 15/163,201

(22) Filed: May 24, 2016

(51) Int. Cl. G08G 5/00; G01C 21/20; G05D 1/00; B64C 39/02; G06Q 10/06; G05D 1/10

(52) U.S. Cl. CPC G08G 5/0039; G06Q 10/06313; G05D 1/101; G05D 1/0005; B64C 39/024; G01C 21/20; B64C 2201/141; B64C 2201/126; B64C 2201/146

(57) ABSTRACT

Disclosed are a method, system, and a computer readable medium for dynamic routing of a drone. The method includes receiving a first flight mission by the drone, the first flight mission having a first cost relating to resources of the drone; flying the drone and capturing data according to the flight mission by a sensor; assessing quality of the captured data; and comparing the quality of the captured data to a pre-defined threshold. If the quality is below the threshold, continue with obtaining a second or further flight mission different from the first flight mission, and flying the drone and capturing data according to the second or further flight mission, the second or further flight mission having a second or further cost relating to resources of the drone. If the quality is equal or above the threshold, continue flying the drone and capturing data according to the current flight mission.

### TECHNICAL FIELD

The present disclosure relates generally to remotely piloted aircraft; and more specifically, to methods and systems for dynamic routing of a drone based on quality of the data captured by the drone in real-time.

### BACKGROUND

Remotely piloted aircraft (RPA), such as drones, are now increasingly being used for a variety of purposes like surveillance, disaster relief operations, aerial inspection, and so forth. Typically, the aerial inspection can be area specific, object specific, and time specific. The area specific aerial inspection may involve performing aerial photography of a defined area using the drone. The object specific aerial inspection may involve performing inspection of the object for example, humans, computers, power grids, and so forth using the drone. The time specific aerial inspection may involve inspecting the area/object at a specific time using the drone. Further, the drone can be used for counting objects in a defined area, creating or updating asset inventory (i.e. maintaining amounts, types and locations of data captured by the drone), condition assessment, damage detection, and the like.

Further, the actual flying of the drone may have a significant associated cost, where the cost is approximately proportional to the needed total time of flights, especially when operated on long distances. On the other hand the purpose of the flight is to capture data, thus there is a need to maximize the useful data capture per flight time unit. Sometimes, the data capture fails or the data is inadequate. For example, in many instances, the data captured by the drone may not be adequate, for example, the quality of the captured images may not be good that makes it difficult to use the images and interpret the outcome of the inspection. This may be due to several reasons such as incorrect flight trajectory, temporary failure of the sensor system, environmental factors such as occlusions, and the like. In such instances, the flight of the drone needs to be performed again for recapturing the data, which can be time consuming and may incur additional cost too. Moreover, the overall cost of an aerial inspection mission gets increased due to re-flights of the drone and logistics.

Therefore, in light of the foregoing discussion, there exists a need to overcome the aforementioned drawbacks associated with the capturing of data by the drones during the flight missions.

### SUMMARY

The present disclosure seeks to provide a method for dynamic routing of a drone.

The present disclosure also seeks to provide a system for dynamic routing of a drone.

The present disclosure further seeks to provide a non-transitory tangible computer readable medium comprising instructions for the execution of a method for dynamic routing of a drone.

In one aspect, an embodiment of the present disclosure provides a method for dynamic routing of a drone, comprising the steps of:

receiving a first flight mission by the drone, the first flight mission having a first cost relating to resources of the drone;

flying the drone and capturing data according to the first flight mission by a sensor of the drone;

assessing quality of each of the captured data; and

comparing the quality of each of the captured data to a pre-defined threshold, wherein:
if the quality is below the pre-defined threshold, continue with obtaining a second or further flight mission different from the first flight mission, and flying the drone and capturing data according to the second or further flight mission, the second or further flight mission having a second or further cost relating to resources of the drone;
if the quality is equal to or above the pre-defined threshold, continue flying the drone and capturing data according to the current flight mission.

In another aspect, an embodiment of the present disclosure provides a system for dynamic routing of a drone, comprising:

an autopilot device configured to:
receive a flight mission at the drone comprising a cost relating to resources of the drone; and
fly the drone according to the flight mission;

a sensor configured to capture data according to the flight mission;

a central processing unit configured to:
assess quality of each of the captured data; and
compare the quality of each of the captured data to a pre-defined threshold, wherein:
   when the quality is below the pre-defined threshold, then instructing the autopilot device to continue with obtaining another flight mission and flying of the drone and the sensor to capture data according to the other flight mission, the other flight mission having another cost relating to resources of the drone; and
   when the quality is equal to or above the pre-defined threshold, then instructing the autopilot device to continue flying of the drone and the sensor to capture data according to the current flight mission; and

a memory coupled to the central processing unit, and configured to store the captured data and received plurality of flight missions.

In yet another aspect, an embodiment of the present disclosure provides a non-transitory tangible computer readable medium comprising instructions for the execution of the method for dynamic routing of a drone as disclosed herein above.

Embodiments of the present disclosure substantially eliminate or at least partially address the aforementioned problems in the prior art, and enables dynamic routing of a drone.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system for dynamic routing of a drone, in accordance with an embodiment of the present disclosure;

FIG. 2 is a block diagram illustrating elements of a drone, in accordance with an embodiment of the present disclosure;

FIG. 3 is a block diagram illustrating elements of a ground station, in accordance with an embodiment of the present disclosure;

FIGS. 4A-B is a flowchart illustrating a method for dynamic routing of a drone, in accordance with an embodiment of the present disclosure;

FIGS. 5A-B is a flowchart illustrating another method for routing of a drone, in accordance with an embodiment of the present disclosure;

FIG. 6A is a schematic illustration of an exemplary flying route along which a drone can fly according to a flight mission, in accordance with an embodiment of the present disclosure; and

FIG. 6B is a schematic illustration of an exemplary flying route along which a drone can fly in case of inadequate data capture, in accordance with another embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method for dynamic routing of a drone, comprising the steps of

receiving a first flight mission by the drone, the first flight mission having a first cost relating to resources of the drone;

flying the drone and capturing data according to the first flight mission by a sensor of the drone;

assessing quality of each of the captured data; and

comparing the quality of each of the captured data to a pre-defined threshold, wherein:
if the quality is below the pre-defined threshold, continue with obtaining a second or further flight mission different from the first flight mission, and flying the drone and capturing data according to the second or further flight mission, the second or further flight mission having a second or further cost relating to resources of the drone;
if the quality is equal to or above the pre-defined threshold, continue flying the drone and capturing data according to the current flight mission.

In another aspect, an embodiment of the present disclosure provides a system for dynamic routing of a drone, comprising:

an autopilot device configured to:
receive a flight mission at the drone comprising a cost relating to resources of the drone; and
fly the drone according to the flight mission;

a sensor configured to capture data according to the flight mission;

a central processing unit configured to:
assess quality of each of the captured data; and
compare the quality of each of the captured data to a pre-defined threshold, wherein:
   when the quality is below the pre-defined threshold, then instructing the autopilot device to continue with obtaining another flight mission and flying of the drone and the sensor to capture data according to the other flight mission, the other flight mission having another cost relating to resources of the drone; and
   when the quality is equal to or above the pre-defined threshold, then instructing the autopilot device to continue flying of the drone and the sensor to capture data according to the current flight mission; and

a memory coupled to the central processing unit, and configured to store the captured data and received plurality of flight missions.

In another aspect, an embodiment of the present disclosure provides a non-transitory tangible computer readable medium comprising instructions for the execution of the method for dynamic routing of a drone as disclosed herein above.

In one embodiment, the system for dynamic routing of a drone is part of the drone. Alternatively, the system for dynamic routing of a drone can be a part of a network device that is communicably coupled to the drone over a wireless communication network. In this instance, the network device is configured to analyze the data captured and received from the drone near in real-time. In an embodiment, the network device may be a computing device configured to exchange data with the drone and process the data received from the drone. The system for dynamic routing of the drone includes an autopilot device, a sensor, a central processing unit, and a memory coupled to the central processing unit.

In some embodiments, the drone is a remotely piloted aircraft that may be configured to receive a flight mission. The drone is configured to receive the flight mission including a cost relating to resources of the drone. For example, the drone can receive a first flight mission including a first cost relating to resources of the drone. In an embodiment, the drone is configured to receive the flight mission remotely from a ground station. Further, an operator present at the ground station may input the flight mission at the ground station for sending to the drone. In another embodiment, a flight mission is sent to the drone when the drone requests for the flight mission based on assessment of captured data.

The drone is configured to fly according to the received flight mission. In an embodiment, the drone is configured to fly along a flying route according to the flight mission. The drone is further configured to capture data according to the flight mission. For example, the drone may capture data about various objects in a specific area by clicking multiple images of the area according to the flight mission.

The drone is also configured to assess quality of each of the captured data. For example, the drone may assess the quality of the clicked images during its flight to identify number of objects in the specific area. In an embodiment, the drone is configured to assess the quality of the captured data during its fight near in real-time.

In a system according to the present disclosure, the drone further includes a sensor configured to capture data according to the flight mission. In an embodiment, the drone includes a number of sensors for capturing data according to the flight mission. In an embodiment the sensor is a camera and the captured data is an image. In alternative embodiment, the sensor is a Light Detection and Ranging (Lidar) sensor and the captured data is a point cloud. Further, the drone may include different types of sensors, such as, but not limiting to, proprioceptive sensors, exterosceptive sensors, exproprioceptive sensors, and so forth. Examples of the proprioceptive sensors may include, but are not limited to, inertial measurement unit, accelerometer, gyroscope, compass, altimeter, Global Positioning System (GPS) module. Examples of the exterosceptive sensors may include, but are not limited to, camera, infrared camera, radio detection and ranging (RADAR) sensor, sound navigation and ranging (sonar) sensor. Examples of the exproprioceptive sensors may include, but are not limited to, internal thermometer, external thermometer, gimballed camera, and the like.

In a system according to the present disclosure, the drone further includes a central processing unit (CPU) configured to assess the quality of the data captured by the sensors of the drone. In an embodiment, the CPU may be a single device or a combination of multiple devices. The CPU of the drone in this case may be communicably coupled to the autopilot device, the sensor(s), and the memory. In some embodiments, the CPU is configured to assess quality of the captured data using generally known methods. Further a cost can be associated with each of the methods used for assessing quality of the captured data. In some embodiment, the known methods for assessing contrast, lighting, sharpness, overlap of images may be used. Further, the methods for assessing density and uniformity of point cloud may be used when the sensor is a Lidar.

The CPU is also configured to compare the quality of each of the captured data to a pre-defined threshold. In an embodiment, when the captured data includes images, then examples of the quality of captured images may include, but are not limited to, a contrast level of the image, a lighting level of the image, a sharpness level of the image, and an overlap of the image with an earlier image. Further examples of the quality of the captured data may include a signal to noise ratio of the data, a coverage of an area, a number of parameters related to object recognition from the captured data, and a number of parameters related to possible obstructions. In an embodiment, when the data is captured using Lidar and includes a point cloud, then in such instance, the quality of captured data includes at least one of a density and a uniformity of the point cloud.

In an embodiment, when the CPU determines that the quality is below the pre-defined threshold, then the CPU instructs the autopilot device to continue with obtaining another flight mission (or second flight mission or further flight mission) and continue the flying of the drone and instruct the sensor to capture data according to the another flight mission (or second flight mission or further flight mission). The other flight mission may include another cost (or second cost or further cost) relating to resources of the drone. For example, when the drone assesses that the quality of the captured data is below the pre-defined threshold then the drone may request another flight mission including another cost relating to the resources of the drone. Also, the drone may take another flying route according to the other flight mission.

In an alternative embodiment, when the CPU determines that the quality is equal to or above the pre-defined threshold, then the CPU instructs the autopilot device to continue flying of the drone and the sensor to capture data according to the current flight mission. In an embodiment, the current flying mission may include at least one of the flight mission and the other (or second) flight mission. In an alternative embodiment, when the CPU determines that the quality is equal to or above the pre-defined threshold, then the CPU instructs the autopilot device to continue flying of the drone according to a modified current mission such as flying the current flight mission route in reverse order.

In an embodiment, the CPU is configured to determine that the captured data is not adequate or the quality of the captured data is not good based on the comparison. In an alternative embodiment, the CPU is configured to calculate another flight mission when the quality of the captured data is not good. In an embodiment, the CPU is further configured to calculate a further cost related to a further flight plan. In one embodiment, the CPU is configured to calculate another flight mission autonomously when the captured data is not adequate and is below the pre-defined threshold. Further, the CPU may be configured to instruct the autopilot device to change a flying route of the drone. Further, the CPU may be configured to compare the current cost associated with the current flight mission with the calculated further cost. In an embodiment, when the CPU determines that the calculated further cost is equal to or lower than available resources of the drone, then the CPU may instruct the autopilot device to continue with comparing the quality of the captured data to the pre-defined threshold. In an alternative embodiment, when the CPU determines that the calculated further cost is more than the available resources of the drone, then the CPU may instruct the autopilot device to continue with the current flight plan. In an alternative embodiment, when the CPU determines that the calculated further cost is more than the available resources of the drone, then the CPU may instruct the autopilot device to terminate the current flight plan.

In another embodiment, the CPU is configured to obtain or request another flight mission from the ground station when the captured data is not adequate and is below the pre-defined threshold.

Further, the CPU may be configured to recalculate the flying route or a new flight plan based on the then-current information, i.e. captured data, for which part of the targeted data is already available. In an embodiment, the CPU may be configured to instruct the autopilot device make immediate correction in the flying route based on the current information. Hence, re-flight of the drone may not be required for recapturing of the data. Further, the CPU may determine or calculate the new flight plan based on one or more parameters, for example, geofencing, range and duration of flight, manoeuvrability of the aircraft, safety considerations, operational speed range of the drone, and impacts to the ground logistics. Examples of the other parameters that may be considered by the drone for calculating the flight plan may include, but are not limited to, flight restrictions, environmental factors such as, wind speed, lighting and visibility, temperature, sensor capability such as, shutter speed of camera, time between successive images, data verification process based parameters such as, time, complexity, reliability, and so forth.

In a system according to the present disclosure, the drone further includes a memory coupled to the CPU. The memory is also configured to store the captured data and received flight missions.

In one embodiment, the drone is configured to fly semi-autonomously. For example, the drone may fly with some control by a human/operator or machine located remotely or located on ground. In such instance, the drone is configured to connect and/or communicate with at least one ground station via a communication network such as, a radio communication network. Further, the drone is configured to communicate with the at least one ground station via more than one communication networks or radio communication networks. In case one network of the multiple networks fails then the drone and the ground station may communicate via other networks of the multiple networks. This may assure communication reliability all the time between the ground station and the drone. Also, the drone may connect and/or communicate with more than one ground station.

Examples of the radio communication network may include, such as, but are not limited to, a point-to-point (p2p) radio network, cellular radio network and satellite radio network. For example, the drone and the ground station may communicate via for example, four mobile internet connections through different telecom or internet operators.

In an embodiment, the ground station and the drone may communicate with each other via a hybrid communication network. For example, a flight mission may be sent via a point-to-point connection, and data is sent back through another radio communication network.

In a system according to the present disclosure, the ground station includes at least one radio receiver, and at least one radio transmitter. The ground station may be configured to transmit a flight mission to the drone. In an embodiment, an operator, for example a human, at the ground station enters the flight mission including instructions to be executed by the CPU of the drone, the flying route, data capture instructions, and so forth, at the ground station. Further, the communication of the ground station with the drone may happen via public radio infrastructure or network, for example, but not limited to, Wi-Fi LAN (WLAN)

In one embodiment, the at least one radio receiver and the at least one radio transmitter are included in a radio system and not in the ground station. The radio system may be a separate system connected to the drone over communication networks such as, the Internet®, Wi-Fi network, Local Area Network (LAN), WLAN, and so forth.

In an embodiment, the at least one radio receiver of the ground station can be software, hardware, firmware, or combination of these. The at least one radio receiver may be configured to receive a communication including a request for a flight mission from the drone via one or more communication or radio communication networks.

In one embodiment, the at least one radio transmitter of the ground station can be a software, a hardware, a firmware, or combination of these. Further, the at least one radio transmitter may be configured to transmit messages or information, such as the flight mission, to the drone through one or more communication or radio communication networks.

In an embodiment, the ground station may also include a processor configured to process one or more requests for flight missions received from the drone. Furthermore, the ground station may include a memory configured to store instructions that can be executed by the processor of the ground station. In one embodiment, the memory also stores the flight missions, flight routes, and so forth.

In an embodiment, the flight mission has a cost relating to resources of the drone. The cost may include an energy usage of the drone and a time needed to execute the flight mission. For example, the cost includes the energy required to take a flying route according to the received flight mission. In another embodiment, the flight mission includes a flying route and at least one data capture instruction. Further, the flight mission may include a set of instructions for the drone to guide the drone along the flight route and to capture the data during its flight. In an embodiment, the flying route for the drone is determined according to area/objects in the area that needs to be surveyed. Examples of flight missions related to power line inspection may include, power line inspection, vegetation management, tree assessment, structure and line rating assessment, and so forth. In an embodiment, the power line inspection mission may include mapping of power line corridors and proposed corridors from basic planning, surface models, ground models to maps and visualizing. In one embodiment, the vegetation management may include mapping vegetation under transmission lines to identify areas of encroachment, measuring the clearance between lines and vegetation. In an embodiment, the tree assessment may include detection and evaluation of trees that threaten to grow or fall into power line. In an embodiment, structure and line rating assessment may include document power lines regarding position of poles/pylons and wires, monitoring aging and overloaded transmission lines, determining line sag, avoiding blackouts caused by improperly rated lines by monitoring assets including towers and transmission lines.

In one embodiment, the data capture instructions include instructions on location for capturing the data and information on a sensor to be used for capturing the data.

In an embodiment, the cost includes the energy required to take a flying route according to the received flight mission. The cost may be related to energy, time, or other parameters of the drone. For example, each second of flight of drone costs energy. Further, increasing altitude and reversing direction of the drone specifically are energy intensive and consumes more energy. Another example of the energy related cost includes the secondary cost elements which are associated with data captured and analysis by the drone, as the on board computing equipment and data capture devices, such as the sensor, also use power. Otherwise, the related cost may include, for example, a mission having a reserved time slot, that is, a specific time slot when the information needs to be captured.

In an exemplary scenario, there can be several drones scheduled to perform data capturing tasks on the same area, and a cost of a mission may be calculated based on a lowest cost for any drone operating on the same area. Then the decision of the next flight mission may also depend on which drone will be able to carry out the mission with the lowest cost. For example in case the data from the current flight mission performed by the first drone does meet the predefined threshold, and a second drone can perform the current flight mission at a lower cost than the first drone, the current flight mission can be allocated to the second drone and a second (or future) flight mission can be allocated to the first drone.

In another exemplary scenario, the drone may land on an optional landing site as a result of, for example, initial flight planning being overly optimistic, changes in the flight plan due to data not meeting the predefined threshold, whether conditions. Then, the cost of using the optional landing site may include the cost related to retrieving the drone from the optional landing site.

In a system according to the present disclosure, the drone includes an autopilot device configured to communicate with a ground station, via at least one radio communication network. The autopilot device is configured to receive a flight mission at the drone. Optionally the flight mission includes a cost relating to resources of the drone. The autopilot device is configured to fly the drone according to the flight mission. The flight mission may be received by the autopilot device. The flight plan received by the autopilot device may not include the cost information for executing the flight plan. Alternatively, the flight plan received by the autopilot device may include the cost information. Further, the autopilot device may be a software, hardware, firmware, and combination of these configured to manage flying of the drone according to the received flight mission.

In an exemplary scenario, the drone may receive a flight mission including one or more flying instructions specifying a flying route, a start point, and end point, and a flying task. For example, the drone is required to start from a point “A” and end at the point “A” itself while taking a turn from a point “T”. Further, the drone is required to take images of three objects “O1”, “O2”, and “O3” present in a specific area. According to the flight missions, the drone can start from the point ‘A”, and take multiple images of objects “O1”, “O2”, and “O3”, then take a turn from a turning point “T” and return back to the start point “A”. The start and end point is same i.e. the point “A” in this flight mission. Further, when the drone determines that the images of the object “O2” is not satisfactorily in a measurable way, then according to the conventional method, the data quality assessment is done after the mission (i.e. once the drone is back on ground on the point “A”), and in this case the flight would need to be redone to get the photo of the object “O2”. Let's assume that the drone has hundred kilo joule of energy from an energy source such as a battery. All devices i.e. the autopilot device, the sensors, the CPU, the memory, and so forth, of the drone may use same source of the energy. Usually, the drone is allowed to use only eighty percent of the energy before it has to land back to a ground.

The energy consumption by the drone may be calculated using following cost functions:
C_{f}=100 joules (J) per second
Cₚ=10 joules per image
Cₐ=30 joules per image
   where “C_{f}” represent energy consumed for flying, “Cₚ” represent energy consumed for capturing a single image, and “Cₐ” represent energy consumed for analyzing or assessing the quality of a single image.

Further, flying the complete flying route may take “tₙ=100 seconds”. Analyzing and assessing quality of images may take “tₐ=1 second”, while currently performing the flight mission and going back to retake the failed images may take “tᵣ=5 seconds”. Hence normal flight cost, if everything goes right and the data captured in one go is adequate, then according to the prior art methods the cost can be calculated using following equation:

Cₙ=tₙC_{f}+3Cₚ

Cₙ=10000 J+30 J

Conventionally, the drone assesses the quality of the captured images after returning back to the start point. If the image of the object “O2” is not adequate, then the drone may require re-flying to location of the object “O2” again and returning back to the start point “A”as per the flying route. Re-flight and recapture of the images of the object “O2” may consume 50 seconds, thus the cost for re-flight will be:

Cᵣ=5000 J+10 J=5010 J

According to the prior art, the total cost “Cₜ” for accomplishing the flight mission by the drone will be:

Cₙ+Cᵣ=15040 J

According to the disclosed systems and methods, the drone analyses and assesses the quality of the captured images during its flight. And when the data captured is adequate in one go by the drone along the flying route, then the cost can be calculated as:

Cₙₐ=Cₙ+3Cₐ=10030 J+90 J=10120 J

The drone as disclosed in the present disclosure is configured to assess the quality of the captured images during its flight in near real-time and determines that the images of the object “O2” is not adequate, then the drone can capture images of the object again while flying back to the start point “A” as per the flying route. As per the flying route, the drone has to return back to the start point “A”, hence the drone can retake the images of the object “O2” again and re-flight of the drone is not required. The total costs including the cost of recapture i.e. 10 j/image will be:

Cₜ=Cₙₐ+Cₚ+Cₐ=10120 J+10 J+30 J=10160 J

Hence, the cost is reduced by using the disclosed methods and systems of dynamic routing of the drone.

The disclosed method and system perform analysis of the captured data during the flight mission and assesses data availability and quality substantially in real-time. As the assessment and comparison are performed during the flight of the drone, therefore, if the data is inadequate then dynamic routing of the drone for data recapturing may be performed during its flight itself. Further, the drone may either re-route autonomously or may request the new flight mission from a ground station and take action accordingly. This in turn may eliminate the need for re-flights and thus reduces overall time and cost for executing the flight mission.

The disclosed method and system for dynamic routing of a drone ensures reliability of data delivery. For example, after a major natural disaster such as a hurricane which has destroyed hundreds of square miles of area, the need for rapid damage assessment is critical. By using the disclosed system and method, better information of the damages is available, hence the better the emergency response is, as the material logistics and field operations can be performed in an prioritized manner i.e. the most critical damages are managed first. These critical damages may be for example blocked roads or damaged bridges, as these damages prevent the access of the field crews for any further restoration work. Ensuring the quality of data from the drone operations by means of the disclosed methods and systems provides means to provide complete and useable data from each drone flight.

In an exemplary scenario, after a hurricane, usually the first 12 hours are most critical in damage assessment as there can be thousands of field crews working and material transports including hundreds of trucks bringing tools and material to enable restoration. The disclosed system can be used in the drones for assessing the damages. Assuming the drone damage assessment flights of the damaged area may take approximately take 6 hours and all the data captured would be of satisfactory quality. The field operations may be planned in optimized and prioritized manner after the data has been received. Without the disclosed methods and systems it may happen that after the 6 hours of drone survey flights, the data would not be complete or of usable quality, the drone flight would need to be partially restarted. Re-flying is expensive and takes time as the drones need to be transferred to the areas of missing or poor quality data which areas may be geographically distributed, that may in turn further increase the cost and time needed. It may be that the reflight of the drone may take 4 hours. Without the disclosed methods and systems, the reflights might also provide insufficient data, causing the need for another set of reflights which could take for example, 1 hour. In total acquiring the data using the traditional methods may take a total of 6+4+1=11 hours. This would be 5 hours more than in case of using the disclosed system and methods, and would cause all the restoration work and material logistics to be suboptimal for 5 hours longer than with the disclosed method. This may cause wrong planning for example, amount of field crews may be dispatched for tasks they cannot complete at all until some other tasks are performed first, material and tools dispatched in wrong locations, too few materials dispatched. All of these problems have a huge societal, economic and safety implications and may also cause casualties as the restoration work is delayed.

### DETAILED DESCRIPTION OF THE DRAWINGS

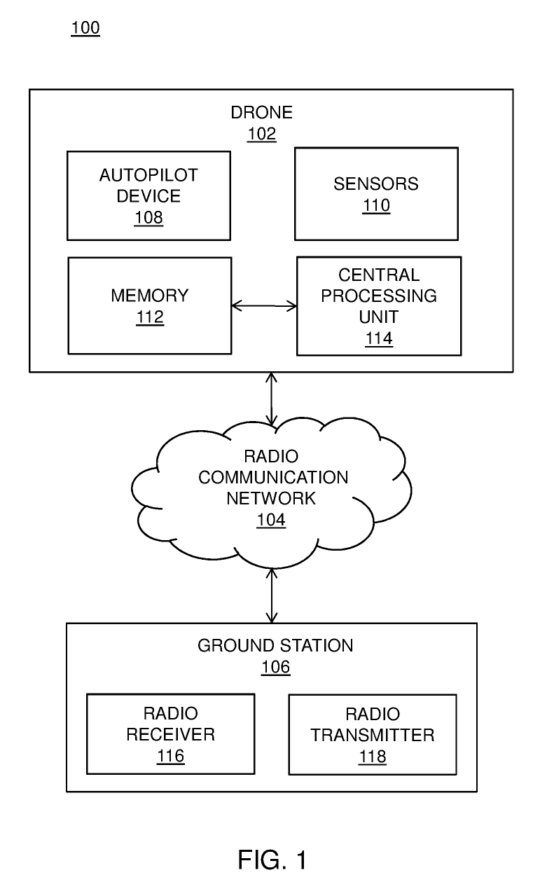

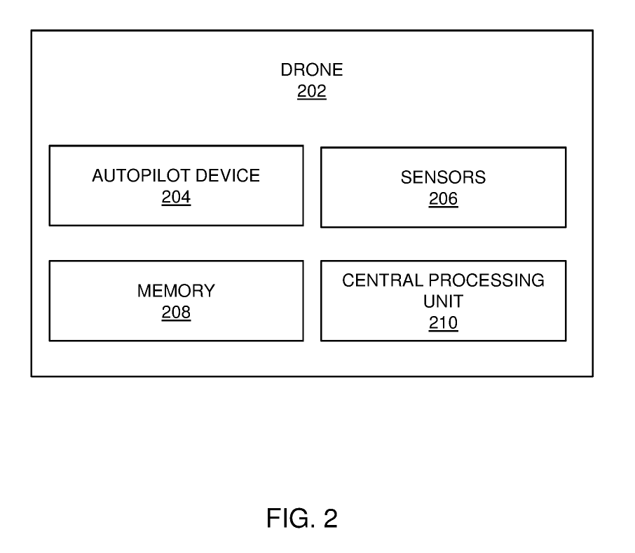

Referring to FIG. 1, illustrated is a block diagram of a system 100 for dynamic routing of a drone 102, in accordance with an embodiment of the present disclosure. The system 100 includes the drone 102 configured to receive flight mission from a ground station 106 via a radio communication network 104. The drone 102 is configured to receive flight mission having a cost relating to resources of the drone. The drone 102 is also configured to fly and capture data according to the flight mission. The drone 102 is further configured to assess the quality of each of the captured data and to compare the quality of each of the captured data to a pre-defined threshold. If the quality is below the pre-defined threshold, then the drone continues with obtaining a second or further flight mission, which is different from the first flight mission or the flight mission received before, and flying the drone and capturing data according to the second or further flight mission. The second or further flight missions have a second or further cost relating to resources of the drone. Further, if the quality is equal to or above the pre-defined threshold, continue flying the drone and capturing data according to the current flight mission. The ground station 106 is configured to send flight mission(s) to the drone 102 via the radio communication network 104. The ground station 106 includes radio receiver 116 and a radio transmitter 118. Further, the drone 102 includes an autopilot device 108, a number of sensors 110, a memory 112, and a central processing unit 114 that are described in detail with reference to FIG. 2.

Referring to FIG. 2, illustrated is a block diagram illustrating elements of a drone 202, in accordance with an embodiment of the present disclosure. As shown, the drone 202 includes an autopilot device 204, a number of sensors 206, a memory 208, and a central processing unit (CPU) 210. The autopilot device 204 is configured to receive a flight mission including a cost relating to resources of the drone 202. The autopilot device 204 is also configured to fly the drone 202 according to the flight mission. The sensor 206 is configured to capture data according to the flight mission. The memory 208 is coupled to the CPU 210 and is configured to store the captured data and received flight missions.

The CPU 210 is also configured to assess quality of each of the captured data and compare the quality of each of the captured data to a pre-defined threshold. When the quality is below the pre-defined threshold, then the CPU 210 can instruct the autopilot device 204 to continue with obtaining another flight mission and flying of the drone 202 and the sensor 206 to capture data according to the other flight mission. The other flight mission has another cost relating to resources of the drone 204. Further, when the quality is equal to or above the pre-defined threshold, then the CPU 210 can instruct the autopilot device 204 to continue flying of the drone 202 and the sensor 206 to capture data according to the current flight mission.

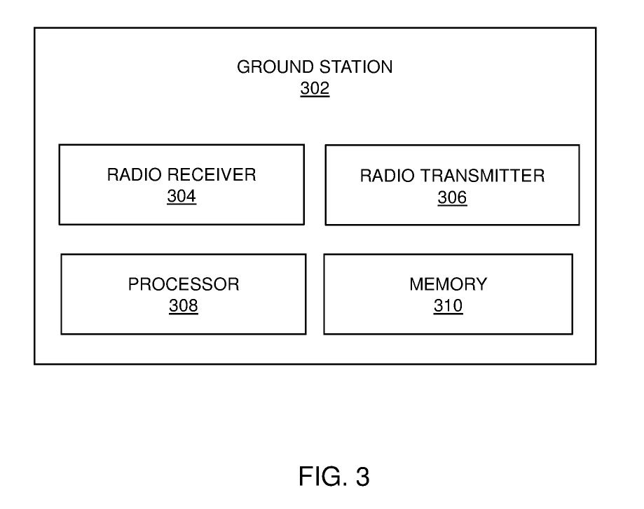

FIG. 3 is a block diagram illustrating elements of a ground station 302, in accordance with an embodiment of the present disclosure. As shown, the ground station 302 includes a radio receiver 304, a radio receiver 306, a processor 308, and a memory 310.

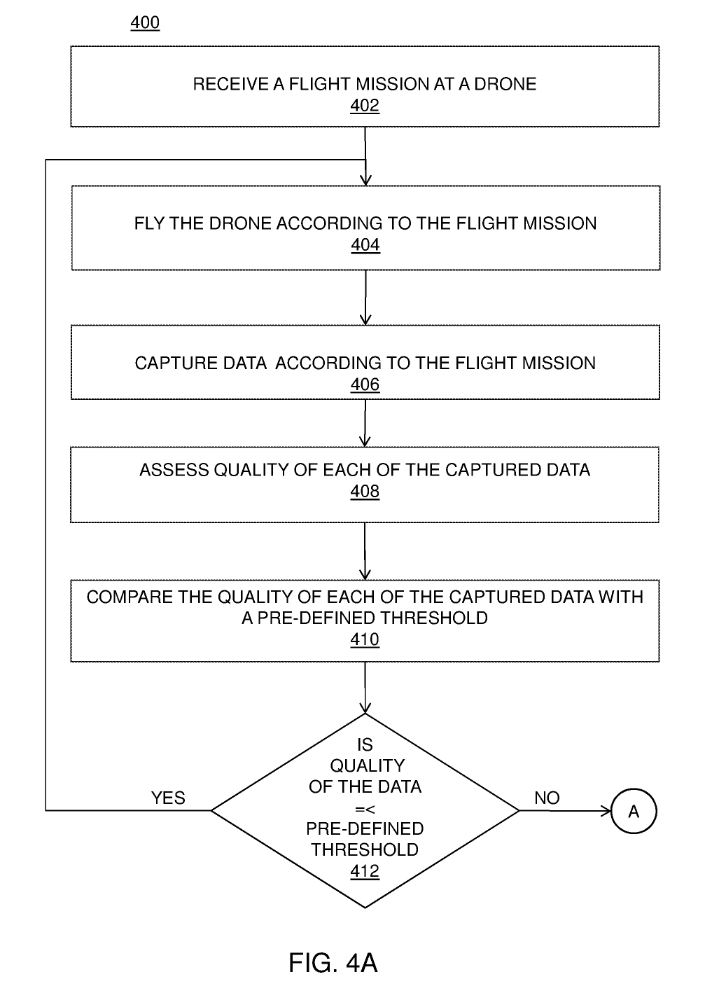

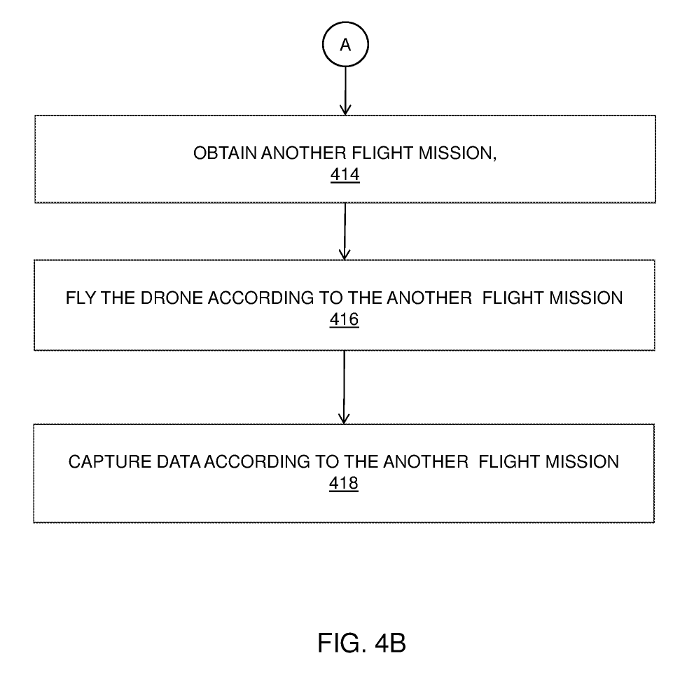

FIGS. 4A-B is a flowchart illustrating a method 400 for dynamic routing of a drone, in accordance with an embodiment of the present disclosure. At step 402, a flight mission is received at the drone. At step 404, the drone flies according to the received flight mission. Then, at step 406, the drone captures the data according to the received flight mission. Further, at step 408, the drone assesses quality of each of the captured data. Then, at step 410, quality of each of the captured data is compared with a pre-defined threshold. Thereafter, at step 412, it is checked whether the quality of the data is equal to or more than the pre-defined threshold. If yes, then step 404 is executed, if no then step 414 is executed. At step 414, another flight mission is obtained by the drone. Then, at step 416, the drone flies according to the other flight mission. Thereafter, at step 418, the drone captures the data according to the other flight mission.

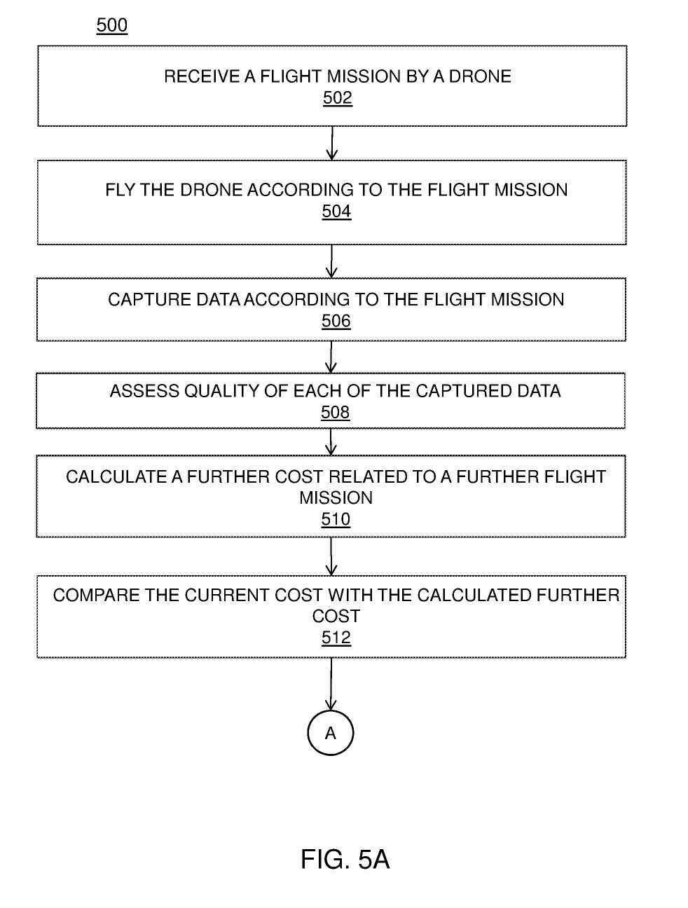

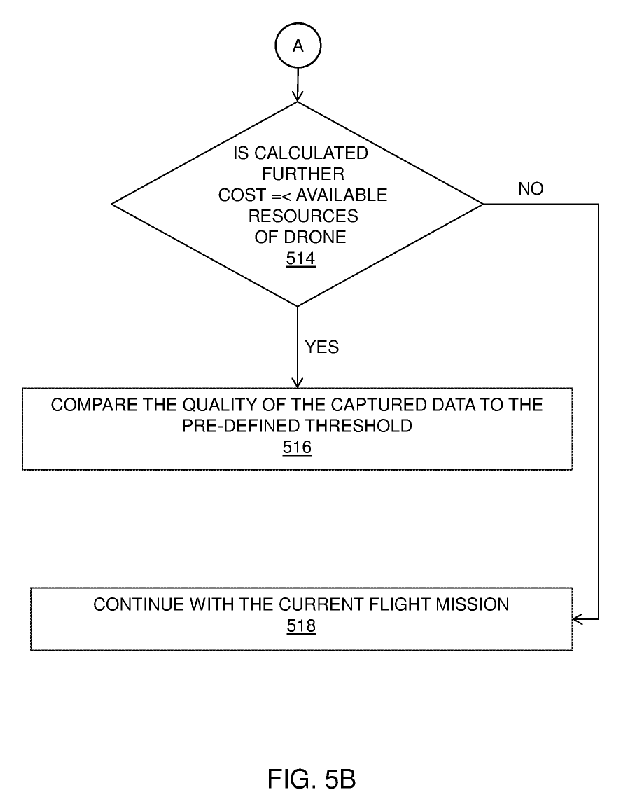

FIGS. 5A-B is a flowchart illustrating another method 500 for routing of a drone, in accordance with an embodiment of the present disclosure. At step 502, a flight mission is received at the drone. The drone flies according to the received flight mission at step 504. At step 506, the drone captures the data according to the flight mission. Then at step 508, the drone assesses the quality of each of the captured data. At step 510, the drone calculates a further cost related to a further flight mission. Then at step 512, the drone compares the current cost with the calculated further cost.

At step 514, it is checked whether the calculated further cost is less than or equal to the available resources of the drone. If yes, then step 516 is performed, and if the cost is more then step 518 is performed. At step 516, the quality of the captured data is compared with the pre-defined threshold. At step 518, the drone continues with the current flight mission when the calculated further cost is more than the available resources of the drone.

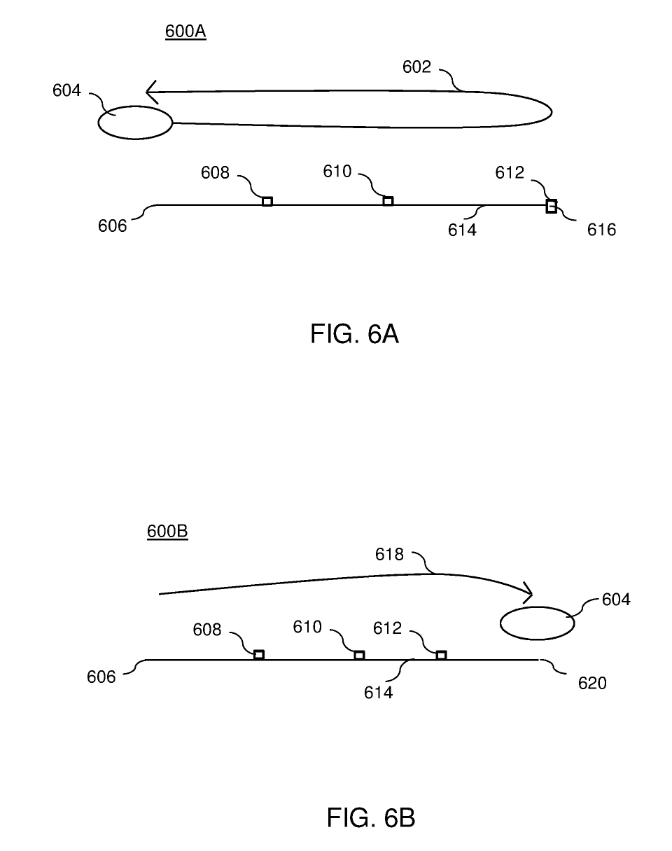

FIG. 6A is a schematic illustration 600A of an exemplary flying route 602 along which a drone 604 can fly according to a flight mission, in accordance with another embodiment of the present disclosure. As shown, the flight mission includes flying instructions for the drone 604. According to the flying instructions, the drone 604 can start from a start point 606, take multiple images of objects 608, 610, and 612 located on a ground 614, then take a turn from a turning point 616 and return back to the start point 610. The start and end point is same i.e. the start point 606 in this flight mission. Therefore, based on the present disclosure, if the images of the object 610 are not satisfactorily in a measurable way, then the drone 604 may recapture the images of the object 610 while returning back to the start point 606.

FIG. 6B is a schematic illustration of an exemplary flying route 618 along which the drone 604 can fly in case of inadequate data capture, in accordance with another embodiment of the present disclosure. As discussed with reference to FIG. 6A, the drone 604 may be initially assigned a flight mission to start from a start point 610 and capture images of the objects 608, 610, and 612 located on the ground 614, and then return back to the start point 610 itself. But, when the drone 604 assesses the quality of the images and determines the failure of capturing of the data during the flight. Then, the drone 604 may communicate this to the ground station (not shown), and the ground station may confirm the retake, or alternatively may order the drone 604 take the flying route 618. When the ground station knows that other drones are scheduled to operate in same area. Thus, the retake the image of the object 610 may be assigned to some other drone, and the drone 604 may be instructed to land at an end point 620 and skip retake of images of the object 610. Further, the drone 604 may take the decision of landing at the end point 620 autonomously without informing to the ground station.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for dynamic routing of a drone, comprising the steps of:
receiving a first flight mission by the drone, the first flight mission having a first cost relating to resources of the drone;
flying the drone and capturing data according to the first flight mission by a sensor of the drone;
assessing quality of each of the captured data; and
comparing the quality of each of the captured data to a pre-defined threshold, wherein:
if the quality is below the pre-defined threshold, continue with obtaining a second or further flight mission different from the first flight mission, and flying the drone and capturing data according to the second or further flight mission, the second or further flight mission having a second or further cost relating to resources of the drone; and
if the quality is equal to or above the pre-defined threshold, continue flying the drone and capturing data according to the current flight mission.

2. A method according to claim 1, wherein the flight mission comprises a flying route and at least one data capture instruction.

3. A method according to claim 2, wherein the at least one data capture instruction comprises instructions on location for capturing the data and the sensor to be used for capturing the data.

4. A method according to claim 1, wherein the sensor is a camera and the captured data is an image.

5. A method according to claim 4, wherein the quality of captured data comprises at least one of a contrast level of the image, a lighting level of the image, a sharpness level of the image, and an overlap of the image with an earlier image.

6. A method according to claim 1, wherein the sensor is a Lidar and the captured data is a point cloud.

7. A method according to claim 6, wherein the quality of captured data comprises at least one of a density and a uniformity of the point cloud.

8. A method according to claim 1, wherein the quality of captured data comprises at least one of a signal to noise ratio of the data, a coverage of an area, a plurality of parameters related to object recognition from the captured data, and a plurality of parameters related to possible obstructions.

9. A method according to claim 1, wherein the step of comparing the quality of the captured data to the pre-defined threshold further comprises:
calculating a further cost related to a further flight plan; and
comparing the current cost with the calculated further cost,
if the calculated further cost is equal to or lower than available resources of the drone, continue with comparing the quality of the captured data to the pre-defined threshold; and
if the calculated further cost is more than the available resources of the drone, continue with the current flight plan.

10. A method according to claim 1, wherein the cost comprises at least one of an energy usage of the drone and a time needed to execute the flight plan.

11. A system for dynamic routing of a drone, comprising:
an autopilot device configured to:
receive a flight mission at the drone comprising a cost relating to resources of the drone; and
fly the drone according to the flight mission;
a sensor configured to capture data according to the flight mission;
a central processing unit configured to:
assess quality of each of the captured data; and
compare the quality of each of the captured data to a pre-defined threshold, wherein:
when the quality is below the pre-defined threshold, then instructing the autopilot device to continue with obtaining another flight mission and flying of the drone and the sensor to capture data according to the other flight mission, the other flight mission having another cost relating to resources of the drone; and
when the quality is equal to or above the pre-defined threshold, then instructing the autopilot device to continue flying of the drone and the sensor to capture data according to the current flight mission; and
a memory coupled to the central processing unit, and configured to store the captured data and received plurality of flight missions.

12. A system according to claim 11, wherein the flight mission comprises a flying route and a plurality of data capture instructions and optionally the plurality of data capture instructions comprise instructions on location for capturing the data and the sensor to be used for capturing the data.

13. A system according to claim 11, wherein the sensor is a camera and the captured data is an image.

14. A system according to claim 13, wherein the quality of captured data comprises at least one of a contrast level of the image, a lighting level of the image, a sharpness level of the image, and an overlap of the image with an earlier image.

15. A system according to claim 14, wherein the sensor is a Lidar and the captured data is a point cloud.

16. A system according to claim 15, wherein the quality of captured data comprises at least one of a density and a uniformity of the point cloud.

17. A system according to claim 11, wherein the quality of captured data comprises at least one of a signal to noise ratio of the data, a coverage of an area, a plurality of parameters related to object recognition from the captured data, and a plurality of parameters related to possible obstructions.

18. A system according to claim 11, wherein the central processing unit is further configured to compare the quality of the captured data to a pre-defined threshold by:
calculating a further cost related to a further flight plan; and
comparing the current cost with the calculated further cost,
if the calculated further cost is equal to or lower than available resources of the drone, continue with comparing the quality of the captured data to the pre-defined threshold; and
if the calculated further cost is more than the available resources of the drone, continue with the current flight plan.

19. A system according to claim 11, wherein the cost comprises at least one of an energy usage of the drone and a time needed to execute the flight plan.

20. A non-transitory tangible computer readable medium comprising instructions for the execution of the method according to claim 1.
